(19) United States
(12) Patent Application Publication
(10) Pub. No.: US 2007/0046866 A1
(43) Pub. Date: Mar. 1, 2007

(54) Color field emission display modules

(75) Inventors: Cheng-Chung Lee, Hsinchu (TW); Yu-Yang Chang, Tainan (TW); Liang-You Jiang, Taipei County (TW); Yau-Chen Jiang, Hsinchu County (TW); Lih-Hsiung Chan, Kaohsiung City (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/282,577

(22) Filed: Nov. 18, 2005

(30) Foreign Application Priority Data
Aug. 24, 2005 (TW) TW94128922

(51) Int. Cl. G02F 1/1335

(52) U.S. Cl. 349/106

(57) ABSTRACT

A field emission display module. A white field emission display (FED) comprises a plurality of dots (pixels) arranged in matrix, generating different gray levels according to external display data. A color filter display is disposed on the white field emission display, generating color images with the gray levels generated by the white field emission display.

### BACKGROUND

The invention relates to display modules, and more particularly, to color field emission display modules.

Field emission displays (FED) are widely used due to low power consumption and high contrast ratio thereof. FIG. 1 shows a conventional field emission display 10 comprising a cathode plate 12 with an electron emission electrode 16, and an anode plate 14 with color fluorescent films 18 (18R, 18B and 18G). Electron field emission is induced between the emission electrode 16 and the color fluorescent films 18 by an electric field generated between the gate layer 121 and the cathode layer 123. A positive bias voltage is applied to the conductive layer 19 on the anode plate 14 to accelerate the emitted electrons toward the color fluorescent films 18, resulting in fluorescence.

However, the color fluorescent films 18R, 18G and 18B have different constituents with a noticeable difference between fluorescent efficiencies thereof. Fluorescent efficiency of green fluorescent films 18G is better than that of red and blue fluorescent films 18R and 18B. For example, fluorescent efficiency of green fluorescent films 18G is 4˜5 times that of the other two kinds of fluorescent films. Further, because fluorescent powders applied to conventional field emission display is high voltage fluorescent powder suitable for CRTs, a higher anode voltage is required, decreasing fluorescent efficiency.

### SUMMARY

Embodiments of a field emission display module are disclosed. A white field emission display (FED) comprises a plurality of dots (pixels) arranged in matrix, generating different gray levels according to external display data. A color filter display is disposed on the white field emission display, generating color images with the gray levels generated by the white field emission display.

The invention also discloses embodiments of flat displays, in which a driver generates a plurality of driving signals according to image data from a host system, with a color field emission display module is coupled to the driver. The color field emission display module comprising a white field emission display (FED) with a plurality of dots arranged in matrix, generating different gray levels according to the driving signals, and a color filter display disposed on the white field emission display, generating color images with the generated gray levels.

The invention also discloses embodiments of a fabrication method for field emission display modules, in which a white field emission display comprising an upper plate and a lower plate is formed. A color filter is formed on the white field emission display, in which there is no liquid crystal gray level controller disposed between the color filter and the white field emission display.

### DESCRIPTION OF THE DRAWINGS

The invention can be more fully understood by the subsequent detailed description and examples with reference made to the accompanying drawings, wherein:

FIG. 1 shows a conventional field emission display;

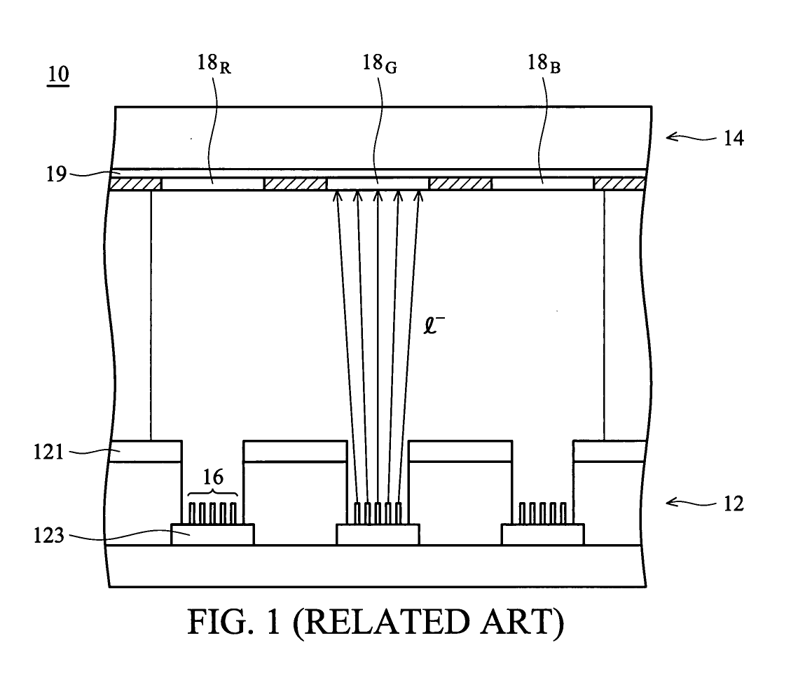

FIG. 2 shows an embodiment of a field emission display module;

FIG. 3 is a structural diagram of the field emission display module;

FIG. 4 shows an embodiment of a flat display; and

FIG. 5 is a flowchart of a fabrication method for field emission display modules of the invention.

### DETAILED DESCRIPTION

Because white fluorescent powders have better fluorescent efficiency than red, green and blue fluorescent powders under lower anode voltage, the invention utilizes a white active matrix field emission display (FED) controlling gray level to cooperate with a color filter to obtain a color field emission display module.

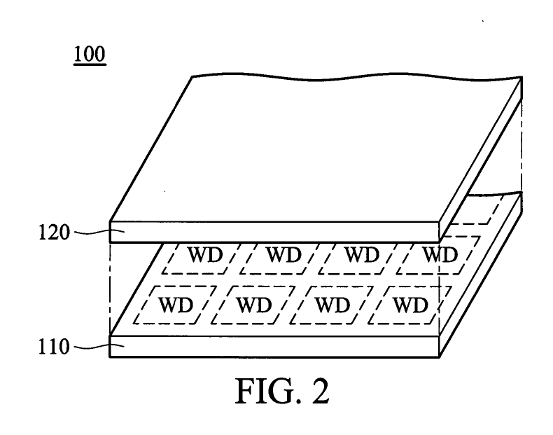

FIG. 2 shows an embodiment of a field emission display module. As shown, the field emission display module 100 comprises a white active matrix FED 110 and a color filter 120. The white active matrix FED 110 comprises a plurality of dots (pixels) WD arranged in a matrix, generating different gray levels according to image data from external circuits, such as a driver or host system. The color filter 120 is directly disposed on the white FED 110. There is no need to dispose another gray level control circuit, such as liquid crystal gray level control unit comprising thin film transistors (TFTs) and liquid crystal layer, between the white FED 110 and the color filter 120. In the invention, a color display is obtained by white FED 110 controlling gray level and a color filter 120, thus generating corresponding color images according to external image data.

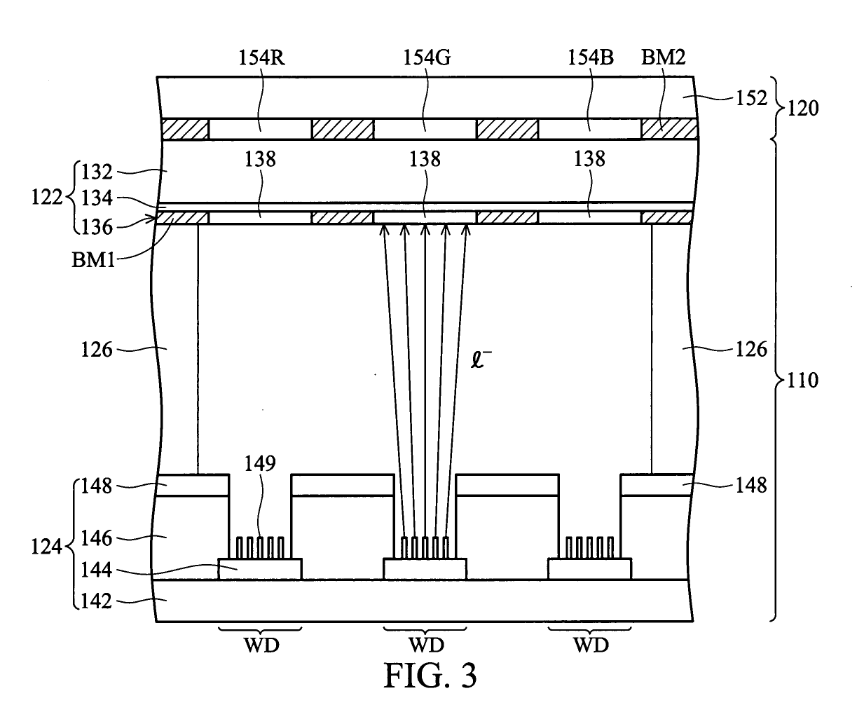

FIG. 3 is a structural diagram of the field emission display module. As shown, the white matrix FED 110 comprises upper plate (anode plate) 122 and a lower plate (cathode plate) 124 separated by spacers 126. The upper plate 122 comprises a glass substrate 132, a transparent conductive anode layer 134, and a white fluorescent layer 136 comprising a black matrix BM1 and a plurality of white fluorescent films 138. The white fluorescent films 138 each contain white fluorescent powder generate white light in response to electron bombardment.

The lower plate 124 comprises a substrate 142, a dielectric layer 146, a gate layer 148 and a plurality of emission electrodes 149. The substrate 142 has a cathode layer 144 and the emission electrodes 149 are electrically coupled thereto. The dielectric layer 146 is disposed on the substrate 142, and the gate layer 148 is disposed on the dielectric layer. The substrate 142 can also be a glass substrate and the emission electrodes 149 can be carbon nanotubes or other electron emission sources.

The white FED 110 applies an electric field between the gate layer 148 and the cathode layer 144, such that emission electrodes 149 emit electrons to white fluorescent layer 138. Further, the transparent conductive anode layer 134 is applied by a positive bias voltage to accelerate and gather the emitted electrons from the emission electrodes 149, and thus, the white fluorescent layer 138 fluoresces as the electrons contact the color fluorescent powder thereof.

Moreover, the color filter 120 disposed on the white matrix FED 110 is a conventional color filter, and comprises a glass substrate 152 and black matrix BM2 and color filter films 154R, 154G and 154B formed below the glass substrate 152.

Because the invention utilizes only white fluorescent powders, fluorescent efficiency is improved by modifying property of fluorescent powders easily as compared with the conventional display modules using three color fluorescent powders. Moreover, because only one color fluorescent powders is required, it is easier and misalignment is thus prevented.

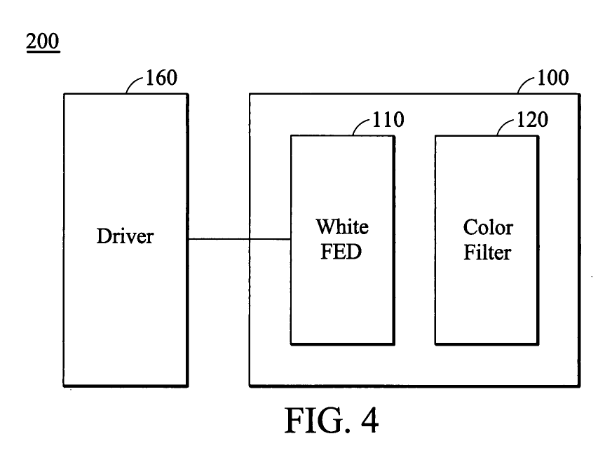

FIG. 4 shows an embodiment of a flat display. As shown, the flat display 200 comprises a color field emission display module 100 shown in FIGS. 2 and 3 and a driver 160. In the color FED module 100 of the invention, the white matrix FED 110 generates different gray levels on dots (pixels) thereof according to driving signals from the driver 160, and generates color images with the color filter 120. There is no need to dispose another gray level control circuit, such as a TFT-LCD, between the white FED 110 and the color filter 120. Further, because the white FED 110 of the invention contains only white color fluorescent powders, the driver 160 is simpler than that of a conventional FED.

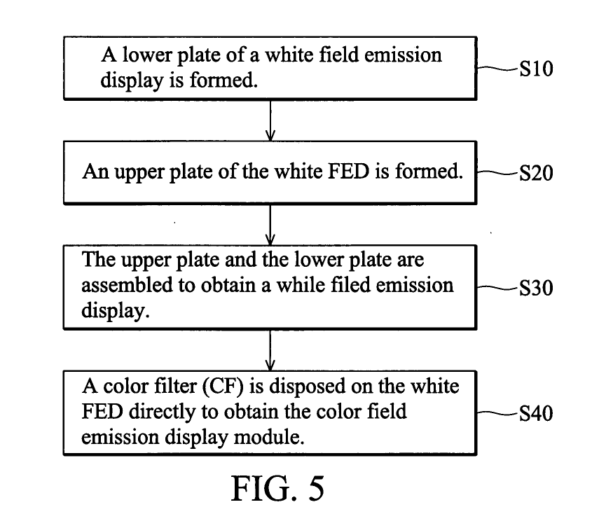

FIG. 5 is a flowchart of a fabrication method for field emission display modules of the invention.

In step S10, a lower plate 124 of a white field emission display is formed by stick film printing. With reference to FIG. 3, the cathode layer 144 can, for example, be formed on the substrate 142 by electroplating or magnetron sputtering. The substrate 142 can be glass, ceramic, oxide, alumina or the like. The emission electrodes 149 are formed on the cathode layer 144 by direct growing or disposed on the cathode layer 144 by transplanting. The formed emission electrodes 149 can, for example, be formed on a Si substrate by chemical vapor deposition and transplanted to the cathode layer 144 by electrically conductive adhesive. The dielectric layer 146 is formed on the substrate 142 by electrophoretic deposition (EPD) or other suitable methods. The dielectric layer 146 can be aluminum, magnesium or other suitable insulation materials. The gate layer 148 is formed on the dielectric layer 146 by electron beam evaporation, thermal evaporation or sputtering.

In step S20, an upper plate 122 of the white FED 110 is formed by stick film printing. For example, the upper plate 122 can comprise a glass substrate 132, a transparent conductive anode layer 134, and a fluorescent layer 136. The transparent conductive anode layer 134 is formed on the glass substrate 122 by a suitable method. The white fluorescent layer 136 is formed on the transparent conductive anode layer 134, which contains white fluorescent materials fluorescing in response electron bombardment.

In step S30, the upper plate 122 and the lower plate 124 are assembled to obtain a while field emission display 110. For example, a black matrix BM1 can be formed on the substrate 122 before the white fluorescent layer 138. Typically, spacers 126 are formed between the upper plate 122 and the lower plate 124 and assembled, and the assembled plates 122 and 124 are vacuumed such that pressure therein is 10⁻˜10⁻⁷ torr, thus, a white FED 110 is finished.

In step S40, a color filter (CF) 120 is disposed on the white FED 110 directly to obtain the color field emission display module 100. In the color FED module 100 of the invention, white matrix FED 110 generates different gray levels on dots thereof according to driving signals from the driver 160, and generates color images with the color filter 120. There is no need to dispose another gray level control circuit, such as a TFT-LCD, between the white FED 110 and the color filter 120. Further, because the white FED 110 of the invention contains only white color fluorescent powder, the driver 160 is simpler than a conventional FED.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A field emission display module, comprising:
a white field emission display (FED) comprising a plurality of dots arranged in matrix, generating different gray levels according to external display data; and
a color filter display disposed on the white field emission display, generating color images with the gray levels generated by the white field emission display.

2. The field emission display module as claimed in claim 1, wherein the color filter is directly disposed on the white field emission display.

3. The field emission display module as claimed in claim 2, wherein the color filter comprises an upper plate with white fluorescent film and the color filter is directly disposed on the upper plate.

4. A flat display, comprising:
a driver generating a plurality of driving signals according to image data from a host system; and
a color field emission display module coupled to the driver, comprising:
a white field emission display (FED) comprising a plurality of dots arranged in matrix, generating different gray levels according to the driving signals; and
a color filter display disposed on the white field emission display, generating color images with the gray levels generated by the white field emission display.

5. The flat display as claimed in claim 4, wherein the color filter is directly disposed on the white field emission display.

6. The flat display as claimed in claim 5, wherein the color filter is disposed on the white field emission display without a liquid crystal gray level controller disposed therebetween.

7. The flat display as claimed in claim 5, wherein the color filter comprises an upper plate with white fluorescent film and the color filter is directly disposed on the upper plate.

8. A fabrication method for field emission display modules, comprising:
forming a white field emission display comprising an upper plate and a lower plate; and
disposing a color filter on the white field emission display, there is no liquid crystal gray level controller disposed between the color filter and the white field emission display.

9. The fabrication method as claimed in claim 8, wherein the color filter is directly disposed on the white field emission display.

10. The fabrication method as claimed in claim 8, wherein formation of the white field emission display comprises:
forming a cathode layer, a gate layer, a dielectric layer and a emission layer on a first substrate to obtain the upper plate of the white field emission display by thick film printing and thin film printing and
forming a white fluorescent film on a second substrate to obtain the lower plate of the white field emission display by thick film printing; and
assembling the upper plate and the lower plate of the while field emission display.

11. The fabrication method as claimed in claim 10, further comprising disposing spaces between the upper plate and lower plate of the white field emission display before assembling the upper plate and the lower plate.
